(19) United States
(12) Patent Application Publication
(10) Pub. No.: US 2024/0042357 A1
(43) Pub. Date: Feb. 8, 2024

(54) FILTER CLEANING DEVICE

(71) Applicants: Christopher LaDue, Puyallup, WA (US); Brittany LaDue, Puyallup, WA (US)

(72) Inventors: Christopher LaDue, Puyallup, WA (US); Brittany LaDue, Puyallup, WA (US)

(21) Appl. No.: 17/879,884

(22) Filed: Aug. 3, 2022

(51) Int. Cl. B01D 41/04

(52) U.S. Cl. CPC B01D 41/04

(57) ABSTRACT

The present invention discloses a universal pool and spa filter cleaning device. The filter cleaning device includes components such as a prime mover (Eg. motor), one or more sets of gears, a drain tube, a mesh sifter, a high-pressure sprayer, a 360-degree sprayer, and an adjustable grabber. The filter cleaning device further includes a lid with latches and a filter locker. The filter is put into a spinning motion by the motor, with sprayer jets coming from inside the filter, thereby allowing the dirt and debris to be sprayed out. It also has sprayer jets going along the outside, cleaning the external area of the filter. This provides a more thorough cleaning than soaking, or than hosing down, and does not utilize chemicals that would in turn un-balance your spa water.

### TECHNICAL FIELD OF THE INVENTION

The present invention relates in general to the field of a cleaning device, and, more particularly, to a filter cleaning device. The present invention focuses on a device and method for cleaning and renewal of cylindrical pleated filters such as pool and spa pleated filters. Thus, the cleaning device disclosed herein is specifically designed for cleaning one or more filters that are commonly used in a pool or spa but should not be construed as limiting to the scope of the present invention.

### BACKGROUND OF THE INVENTION

Spas and pools have become very popular for recreation as well as for therapeutic purposes, and are common in both household and commercial settings. Routine cleaning, maintenance, and upkeep are critical procedures in order to ensure a hygienic environment for pool and spa users. Most spas or pools operate with a filtration function, which circulates the pool water through a filter or filters in order to remove particulate and other water contaminants. Specifically, many pools use a cylindrical pleated filter to remove solid contaminants. The filter is generally designed to filter out and remove microscopic and large particles from the water, which otherwise can potentially clog plumbing and pumping systems, accumulate on hard surfaces, and otherwise create hazards to the operation and use of the pool. Many pools and spas utilize a multiple-layer filter that is cylindrical in shape and is manufactured of a pleated paper-like porous material. The pleats function to increase the surface area, which improves the performance of the filter. Manufacturers of the pleated filters prescribe that filters be replaced on a schedule or when necessary based on the accumulation of contaminants. As a filter accumulates contaminants, it generates increasing restrictions on water flow through the filter, and total filtration declines. Eventually, if not replaced, a filter will become clogged and no filtration will occur. As such, a clean, functioning filter is very important to the operation of a pool or spa. The filters themselves are a specialty product that poses a nontrivial expense to a pool owner or operator. Therefore, it is desirable to be able to extend the life and operation of the filter in order to reduce the cost of operation of the pool. It is possible to clean such filters and renew the filtration capacity. However, regular cleaning of these filters is required for proper filter operation. One problem with cleaning these types of pool and spa filters is the particular geometry of the pleats. The pleats are often very closely packed and therefore inhibit a user from effectively viewing or accessing the filtration surface of the pleat. The result is that contaminants that have been trapped in the crease of the pleat are difficult to remove.

A popular method for cleaning is therefore to use a pressurized rinse, typically using a garden hose, to wash the filter. However, this method is not particularly effective at removing most of the contaminants, as well as being a very time-consuming process. The process is time consuming because of the large number of pleats, and the need to address or clean the length of each pleat individually. Alternatively, a pool operator may soak the filter in water, solvent, cleaning solution, or detergent. In general, soaking the filter is only effective if used in combination with the pressurized rinse method. Furthermore, soaking the filter in a chemical solution can alter the balance of the existing water chemicals, and hosing it down is wet, messy, and along with soaking, ineffective because the user cannot effectively reach dirt and grime residing deep within the pleats. Furthermore, because of the traditional mode of operation of such cylindrical filters, contaminants accumulate on the outward-facing surfaces of the pleats. The pressurized rinse method of cleaning generally only permits a user to introduce a jet of water aimed at those outer surfaces and therefore can tend to drive contaminants further into the pores of the filtration material. Accordingly, there is a need for a device that will facilitate the effective cleaning of a pool or spa filter that can reduce the amount of time required to clean the filter and effectively remove most of the contaminants. Thus, in light of the above limitation and need, the present invention discloses a universal filter cleaning device that will be highly efficient and effective for the purpose of cleaning or renewing cylindrical pleated filters.

### BRIEF SUMMARY OF THE INVENTION

To minimize the limitations in the prior art, and to minimize other limitations that will be apparent upon reading and understanding the present specification, the present invention describes a cylindrical pleated filter cleaning device that will be highly efficient and effective. The disclosed invention is a significant improvement in the state of the art by allowing a user to simply and effectively clean a cylindrical pleated filter. The device employs a system of strategically positioned and oriented pressurized water jets, as well as a centrifuge-like technology to enable thorough and effective cleaning. The device can be operated using either heated or unheated water. The device dramatically reduces the amount of labor required to manually clean a pleated filter, while producing a far more thorough cleaning, while reducing or eliminating the need for chemical cleaning agents over existing methods. Use of the disclosed filter cleaning device may help in expediting filter cleaning, eliminating the use of chemicals in the cleaning process, and extending the usable life of pool and spa cleaners.

In principle the device is a container adapted to hold, spin, and wash the filter using pressurized water jets. A central post operates to position jets proximal to the central axis of the cylindrical filter, with these jets being oriented to direct water outward toward the inner surface of the filter. Other jets are positioned on the walls of the container and are positioned and oriented to direct water inward toward the outer surfaces of the filter. The filter cleaning device further includes a bottom mesh sifter, a spinning mechanism, and a drain tube. The filter cleaning device has been designed for cleaning one or more cylindrical pleated filters such as those found in pools or spas, as applicable and without any limitation. The filter cleaning device is configured to utilize water pressure directed outwardly from the centre of the spa or pool filter to effectively remove the contaminants disposed of on the spa or pool filter. The filter cleaning device is relatively inexpensive and easy to use.

Various advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood by those in the industry are not depicted in order to provide a clear view of the various embodiments of the invention.

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates various components of a filter cleaning device, according to an exemplary embodiment of the present invention.

FIGS. 2A-2B is a diagram that illustrates a conventional cylindrical pleated filter, according to an exemplary embodiment of the present invention.

### DETAILED DESCRIPTION OF THE INVENTION

Before describing the present invention in detail, it should be observed that the present invention utilizes a combination of components, which constitutes a filter cleaning device that has been designed for cleaning one or more filters that are commonly used in a pool or spa. Accordingly, the components have been represented, showing only specific details that are pertinent for an understanding of the present invention so as not to obscure the disclosure with details that may be readily apparent to those with ordinary skill in the art having the benefit of the description herein. As required, the detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

The filter cleaning device of the present invention will now be described with reference to the accompanying drawings, which should be regarded as merely illustrative without restricting the scope and ambit of the present invention.

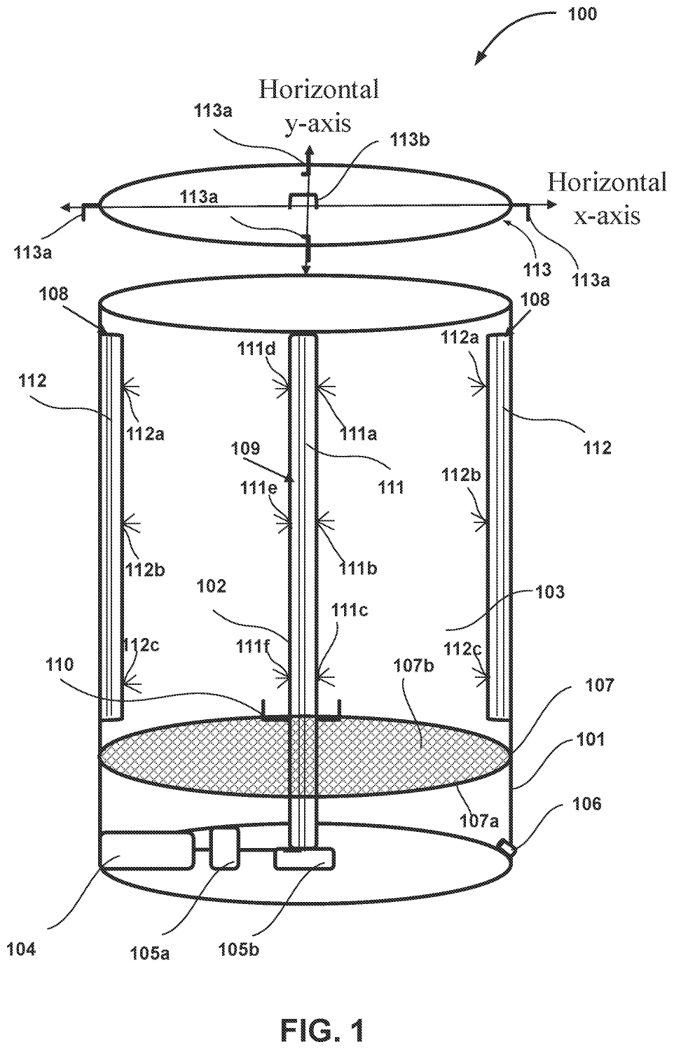

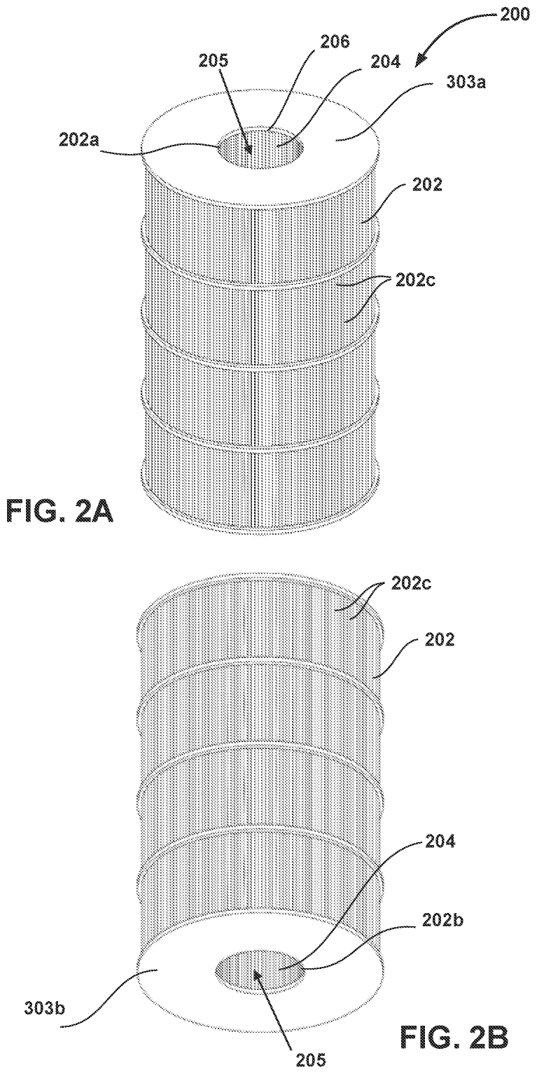

FIG. 1 is a diagram 100 that illustrates various components of a filter cleaning device 100 for cleaning a filter, according to an exemplary embodiment of the present invention. Filters commonly used in swimming pool or spa filtration systems may be made of pleated sheets of paper formed into a cylinder that is open at both ends as shown in FIGS. 2A and 2B. Elastomeric annular disks (denoted as 303a, 303b) at the two ends of the filter 200 act to retain the paper filtration material and provide sealing surfaces. The filter 200 is normally used or configured inside a metal filter housing of the water source (Eg. spa) requiring filtration, from which it must be periodically removed for cleaning and inspection.

The filter cleaning device 100 may comprise components such as a hollow and perforated spindle/mandrel 102, a prime move 104, one or more sets of gears such as gears 105a, 105b, a drain 106, a mesh sifter 107, one or more outer sprayers 108, one or more inner sprayers 109, and a grabber 110, as shown in FIG. 1. The filter cleaning device 100 may further include a lid 113 with one or more latches 113a and a filter locker 113b, as shown in FIG. 1. The inner sprayers 109 are mounted along a vertical cylindrical spindle 102. For example, the inner sprayers 109 are configured inside and at least partially along the hollow spindle 102.

The filter cleaning device 100 has a housing 101 forming an outer shell around an inner portion or space 103 including the components such as the spindle 102, the prime mover 104, the gears 105a, 105b, the drain 106, the mesh sifter 107, the sprayers 108,109, and the grabber 110. The filter 200 in the form of a cylindrical pleated filter 200 (as shown in FIGS. 2A and 2B) that needs to be cleaned typically includes an exterior surface 202 and an interior surface 204 and a central core or tube 206. The pleats 202c are secured to the central core 206. The central core 206 may be made of filter or non-filter material. The filter 200 includes an upper opening 202a and a lower opening 202b formed at the top and bottom surfaces of the filter 200, particularly on the elastomeric annular disks 303a, and 303b respectively. The upper opening 202a leads into a central passage 205 through the filter 200 that extends all the way to meet the lower opening 202b. It should be understood that the filter 200 as shown in FIGS. 2A and 2B is shown for exemplary purpose only. The overall dimensions of the filter cleaning device 100 may vary, depending upon the particular size and shape of the filter 200 to be cleaned.

Means are provided to mount the filter 200 inside the housing 101, so that the filter element 200 may be selectively rotated relative to the housing 101 by the prime mover 104. A means 111 for delivering a rinsing liquid to the central core 206 of the filter element 200, while the filter element 200 is rotating, is also provided. The rinsing liquid delivery means 111 may be a spray bar, extending at least partially along the length of the filter element 200. The spray bar 111 includes a plurality of nozzles 111a-111f spaced out along the length of the spray bar 111 for atomizing the rinsing liquid. The rinsing liquid delivery means 111 is preferably embodied within the hollow mandrel/spindle 102. Further, a rinsing liquid delivery means 112 may be fixedly attached to the interior sides of the housing 101. The rinsing liquid delivery means 112 is a spray bar. In the example shown, there are two such rinsing liquid delivery means 112 are shown configured attached within the interior wall of the housing 101. However, it should be understood that any number of such rinsing liquid delivery means 112 may be used. The spray bars 112 include a plurality of nozzles 111 spaced out along the length of the spray bars 112 for atomizing the rinsing liquid. During operation or the cleaning process, the rinsing liquid is distributed to the interior surface 204 of the filter element 200 (via the rinsing liquid delivery means 111), and the centrifugal force created by rotating the filter element 200 drives the rinsing liquid from the interior surface 204 to the exterior surface 202 of the filter element 200, thereby removing accumulated particulates on the exterior surface 202. Further, the rinsing liquid delivery means 112 delivers or distributes the ringing liquid to the filter on the outer surface 202 of the filter element 200. The filter element 200 is mounted on a perforated, hollow mandrel/spindle 102, such that both the filter element 200 and mandrel 102 may be rotated together relative to the housing 101, by the prime mover 104. The prime mover 104 may be a mechanical prime mover such as a motor, lead screw, a hydraulic prime mover, a pneumatic prime mover, a hydro-pneumatic prime mover, a magnetic prime mover, or an electromagnetic prime mover. The spray bar 111 for delivering the rinsing liquid is positioned inside the hollow mandrel/spindle 102, and the spray bar 111 is secured in a fixed position, while the mandrel 102 and filter element 200 are rotated during self-cleaning. The spray bar 111 has nozzles along its length for uniformly delivering the rinsing liquid. In one embodiment, the spray bar has nozzles spaced out along its length for atomizing the rinsing liquid. The rinsing liquid collects in trough and is drained from the housing 101.

In an embodiment, the prime mover 104 (such as a DC electric motor) is designed and configured to produce a high-speed spinning motion of the spindle 102 and filter 200. In another embodiment, the spindle may be moved up and down and rotated simultaneously. In an embodiment, the metal tub is designed and configured to contain the water and filter. In an embodiment, the water sprayers 108, 109 are designed and configured to assist with the cleaning of the filter 200. In an embodiment, the grabber 110 operates to lock the filter element 200 in relation to the spindle 102. In an embodiment, the mesh sifter 107 is designed and configured to protect large particulates from draining out through the drain tube 106. In an embodiment, the gears 105a,105b are provided to assist the motor 104 with moving the spinning mechanism. In an embodiment, the drain 106 is designed and configured to drain excess water after the cleaning cycle is complete. The lid 113 is designed and configured for locking the filter cleaning device from its top (via disk 303a). There is also provided a locking mechanism (such as the filter locker 113b) that is secured in place by locking the lid 113 to the filter cleaning device 100 from the top 303a. The lid 113 also includes a plurality of latches 113a such that first two latches are opposite to each other along the lid 113 and are placed along a horizontal x-axis and other two latches are opposite to each other along the lid 113 and are placed along a horizontal y-axis as shown in FIG. 1 using arrows. These latches 113a may be used to fasten the lid 113 with the cylindrical tube portion (or the housing 101) of the filter cleaning device 100.

In operation, the proposed hot tub or pool, or spa filter cleaning system 100 may be used by a user where the user places the filter 200 within the housing 101. Further, the central post or spindle 102 containing 360-degree sprayer 109 assists with securing the filter 200 in place. Further, the lid 113 is placed on from the top 303a of the filter 200 mounted within the housing 101, and the machine (i.e., the motor 104) is turned on. The motor 104 may run with either water power, or electric power. It can be modified for commercial use, or for home use. Ideally, it would be made with a rust-free metal, but may be made with any waterproof material without limiting the scope of the present invention. The spindle 102 may slide up and down through the inner portion 103, and may be rotated within the inner portion 103 of the housing 101 so that the one or more sprayer nozzles 111a-111f may be raised and lowered to direct their spray against the upper and lower portions of the filter 200 (particularly to the upper and lower portion of the central core 206), and so that the sprayer nozzles 112a-112c may be rotated to direct its spray around the exterior surface 202 of the filter 200, as desired. The relatively high pressure and/or flow rate of the one or more sprayer nozzles 111a-111f permits an effective cleaning of the filter. Different types of spinning or rotating motion for spinning or rotating the sprayer nozzles 111a-111f may include at least one of rotary motion, oscillatory motion, linear motion, reciprocating motion, or any combination thereof. These motions may be incorporated in a uniform or non-uniform manner in one or more dimensions. However, a person having ordinary skills in the art would understand that these examples have been included only for illustrative purpose and should not be construed as limiting to the scope of the present invention.

The filter cleaning device 100 may accommodate either a single long cartridge or two or more stacked shorter cartridges such as spa filters. The example in FIGS. 2A and 2B shows four stacked shorter cartridges forming a spa filter. The pool owner or pool cleaner loads the filter 200 into the housing 101 of the device 100 and turns on the device 100. In other examples, the spray bar 111 comprises two more spaced apart nozzles 111a-111f. In the example shown there are six nozzles. As the filter 200 is rotated, the spray bar 111 comprising one or more pressurized sprayer nozzles 111a-111f mounted on the spray bar 111 is driven in a direction parallel to the longitudinal axis of the filter cartridge or element 200. Water is provided from a pressurized water source such as a garden hose or reservoir and recirculation pump, and sprayed on the outside surface 202 of the filter. The sprayer nozzles 111a-111f and 112a-112c provide directed water flow and pressure to penetrate between pleats 202c on the filter surface 202 in order to remove debris from the outside of the filter 200. In some examples, a single nozzle is provided. In other examples, two or more nozzles are provided and are oriented axially or longitudinally with respect to the cartridge filter 200. One or more nozzle spray patterns may be triggered to penetrate pleats 202c on the filter 200 in order to dislodge debris, and to wash debris away from the filter 200. Various spray pattern types of nozzles may include, but are not limited to, flat fan nozzles, solid stream nozzles, full cone nozzles, hollow cone nozzles, misting nozzles, solid stream nozzles, air atomising nozzles, and the like. The nozzles are made from brass, plastic, nylon, stainless steel and ceramic. Brass nozzles are the least expensive but are soft and wear rapidly. Nylon and plastic nozzles resist corrosion, but some chemicals can cause these materials to swell. Stainless steel and ceramic nozzles are harder and usually last longer.

In an embodiment, when the prime mover 104 (Eg. motor) is turned on, the motor 104 spins the hot tub filter 200 at a high speed while the water sprayers 109,108 (both inside the filter 200, and outside the filter 200 and attached to the spindle, and along the sides inside the housing 101) spray the high-pressured water. When the device 100 stops its cleaning process, the large particulates such as debris are filtered out with a mesh screen to be manually disposed of, while the excess water drains out of the bottom as wastewater. The motor 104 may be electrically or hydraulically powered. A variety of mechanisms may be used to produce the high-speed spinning motion, including strategically oriented jets of water, a water turbine, a human-powered crank, or another similar mechanism. A person having ordinary skills in the art would understand that each part of the filter cleaning device must be durable and capable of operating in the presence of water.

FIGS. 2A and 2B are diagrams that illustrate a conventional cylindrical pleated filter particularly a sample hot tube filter 200, according to an exemplary embodiment of the present invention. As shown, the hot tube filter 200 consists of an openings 202a,202b on top and bottom, and the top and bottom are covered by the elastomeric annular disks 303a, and 303b. The exterior portion of the filter element may be provided with corrugated filter panels. The corrugated panels serve as pleat spacers and provide airflow channels to the inside pleat folds. These additional airflow channels mean that a higher surface area of the filter media can be used in the filtration process.

The filter cleaning device 100 includes the spray bars 111, and 112 consisting of nozzles 111a-111f, and 112a-112c configured as the inner and outer sprayers. The filter element 200 to be cleaned may be subjected to rotation about the array of nozzles 111a-111f, and 112a-112c and spun about a vertical axis (up and down) by the action of the spray. The rotation can be fast enough that centrifugal forces aid in the cleaning operation by sloughing dirt off the outside of the filter 200. The speed of rotation may be controlled by setting the orientations of the nozzles. For example, if one has a nozzle array that spins the filter too fast, one can rotate one of the nozzles about a horizontal axis so that it provides a braking spray. Another array of nozzles may be provided external to the filter element to be cleaned. This array directs a spray against the upstream face of the filter and aids in sloughing dirt off that side of the filter cartridge. The external and internal arrays of nozzles are used together to control the rate of rotation of the cartridge being cleaned.

The sprayer nozzles 111a-111f, and 112a-112c may be any suitable type of water sprinkler head but is preferably a cylindrical sprinkler head that emits jets of water normal to its axis and has apertures radially spaced apart about its circumference to simultaneously spray the 360° inner surface of the cylindrical pool filter 200. The sprayer nozzles 111a-111f, and 112a-112c are preferably made of brass and may be screwed into or adhesively bonded to the central pipe, which may conveniently be made of polyvinyl chloride, but should not be construed as limiting the scope of the present invention. Since the filter element 200 is subject to being torn if it hangs up on a nozzle while being placed on or removed from the apparatus, it is preferred to provide smooth outer ends on the nozzles 111a-111f, and 112a-112c. The sprayers 108,109 may comprise nozzles of different spray patterns, such as a directed flow to dislodge debris or particulates from the filter 200, and a broader cone or flat spray pattern to wash debris or particulates away from the filter 200.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

1. A filter cleaning device (100), comprising:
a housing (101) having an inner portion (103), the inner portion (103) comprising:
a hollow spindle (102) configured for receiving a filter element (200) with a central core (206), the spindle (102) is rotated and moved up and down relative to the housing (101) within the inner portion (103) of the housing (101) by a prime mover (104), wherein the spindle (102) is configured to embody at least one first sprayer (109) including a first rinsing liquid delivery means (111) for delivering rinsing liquid to the central core (206) of the filter element (200), while the filter element (200) is being rotated and moved up and down;
a grabber (110) adapted for locking the filter element (200) with respect to the spindle (102);
a drain tube (106) configured to drain out excess water from the housing (101) after the cleaning cycle of the filter element (200) is complete;
a mesh sifter (107) configured to protect large particulates from draining out through the drain tube (106);
one or more sets of gears (105a, 105b) provided to assist the prime mover (104) in rotating and moving the filter element (200) relative to the housing (101); and
at least one second sprayer (108) including a second rinsing liquid delivery means (112) fixedly attached to the interior of the housing (101) for delivering the rinsing liquid to the exterior surface (202) of the filter element (200), while the filter element (200) is being rotated and moved up and down.

2. The filter cleaning device (100) of claim 1, wherein the first rinsing liquid delivery means (111) is a spray bar extending at least partially along the length of the filter element (200) or the spindle (102).

3. The filter cleaning device (100) of claim 2, wherein the spray bar (111) comprises a plurality of nozzles (111a-111f) spaced out along the length of the spray bar (111) for atomizing the rinsing liquid passing therethrough.

4. The filter cleaning device (100) of claim 2, wherein the spray bar (111) for delivering the rinsing liquid is fixedly positioned inside the spindle (102), while the spindle (102) and filter element (200) is rotated and moved up and down during self-cleaning.

5. The filter cleaning device (100) of claim 3, wherein the plurality of nozzles (111a-111f) is configured in one or more nozzle spray patterns which when triggered penetrates pleats (202c) on the filter element (200) in order to dislodge particulates and to wash particulates away from the filter (200).

6. The filter cleaning device (100) of claim 1, wherein the rinsing liquid delivered to the central core (206) of the filter element (200), while the filter element (200) is being rotated is further acted upon by a centrifugal force created by rotating the filter element 200 that drives the rinsing liquid from the interior surface (204) to the exterior surface (202) of the filter element (200), thereby removing accumulated particulates on the exterior surface (202).

7. The filter cleaning device (100) of claim 1, wherein the prime mover (104) is a DC electric motor.

8. The filter cleaning device (100) of claim 1 further comprises a lid (113) configured for locking the filter cleaning device (100) from its top (303a).

9. The filter cleaning device (100) of claim 8, wherein the lid (113) comprises a plurality of latches (113a) such a first pair of latches are opposite to each other along the lid (113) and are placed along a horizontal x-axis and a second pair of latches are opposite to each other along the lid (113) and are placed along a horizontal y-axis

10. The filter cleaning device (100) of claim 8, wherein the lid (113) comprises a filter locker (113b) for locking the top of the filter cleaning device (100).

11. The filter cleaning device (100) of claim 1, wherein the first sprayer (109) including the first rinsing liquid delivery means (111) is a 360-degree sprayer.

12. The filter cleaning device (100) of claim 1, wherein the second rinsing liquid delivery means (112) is a spray bar extending at least partially along the length of the filter element (200).

13. The filter cleaning device (100) of claim 12, wherein the spray bar (112) comprises a plurality of nozzles (112a-112c) spaced out along the length of the spray bar (112) for atomizing the rinsing liquid passing therethrough.

14. The filter cleaning device (100) of claim 13, wherein the plurality of nozzles (112a-112c) is configured in one or more nozzle spray patterns which when triggered penetrates pleats (202c) on the filter element (200) in order to dislodge particulates and to wash particulates away from the filter element (200).

15. The filter cleaning device (100) of claim 1, wherein the filter element (200) is a cylindrical pleated filter consisting of at least a single long cartridge or two or more stacked shorter cartridges.
